(19) United States
(12) Patent Application Publication
(10) Pub. No.: US 2023/0146684 A1
(43) Pub. Date: May 11, 2023

(54) FIBER OPTIC CONNECTOR HAVING IMPROVED CABLE TERMINATION ALONG WITH CABLE ASSEMBLIES AND METHODS OF MAKING THE SAME

(71) Applicant: Corning Research & Development Corporation, Corning, NY (US)

(72) Inventors: Luiz Alberto Lourenco Rozo, Rio de Janeiro (BR); Yuri Dario Popadiuk, Rio de Janeiro (BR); Willian Souza Silva, Rio de Janeiro (BR)

(21) Appl. No.: 17/982,581

(22) Filed: Nov. 8, 2022

Related U.S. Application Data
(60) Provisional application No. 63/277,823, filed on Nov. 10, 2021.

(51) Int. Cl. G02B 6/38; G02B 6/44

(52) U.S. Cl. CPC G02B 6/3857; G02B 6/443; G02B 6/4479

(57) ABSTRACT

Fiber optic connectors having improved cable termination for attaching the strength members of a fiber optic cable to a crimp body along with cable assemblies and methods of making the same are disclosed. The fiber optic connectors and cable assemblies provide a robust cable termination so that the fiber optic jacket of the fiber optic cable is inhibited from slipping relative to the fiber optic connector when tensile force are applied to the terminated cable. The fiber optic connector allows a mechanical attachment of the strength members of the cable to a crimp body having first and second shells with respective through windows at a rear portion. One or more strength members of the cable are routed from an interior passage of the crimp body through the respective through windows so that the strength members may be secured between an outer barrel of the crimp body and a crimp band for transferring tensile forces to the strength members, rather than the cable jacket.

### CROSS REFERENCE TO RELATED APPLICATIONS

This application claims the benefit of priority of U.S. Provisional Application Serial No. 63/277823 filed on Nov. 10, 2021, the content of which is relied upon and incorporated herein by reference in its entirety.

### FIELD

The disclosure is directed to fiber optic connectors having improved cable termination for attaching the strength members of a fiber optic cable to a crimp body along with cable assemblies and methods of making the same.

### BACKGROUND

Optical fiber is increasingly being used for a variety of applications, including but not limited to broadband voice, video, and data transmission in a variety of new and expanding applications. As bandwidth demands increase optical fiber is migrating deeper into these new communication networks such as fiber to the premises applications, 5G applications and the like. As optical fiber extends deeper into these communication networks there exist a need for quickly and easily making optical connections in a quick and easy manner for the demands of these new application spaces.

Optical fiber connectors are an essential part of optical fiber communication systems, and are used for terminating an optical transmission component such as an optical fiber of a fiber optic cable. Fiber optic connectors were developed for making one or more plug and play optical connections using a suitable fiber optic connector for the given application. Fiber optic connectors provide a node for mating and demating to the optical network and provide the flexibility of locating the connection points in convenient locations for efficient network assembly, design and/or deployment. Optical fiber connectors are widely used for providing a mating/unmating connection point in an optical network, connecting different optical fibers, and terminating optical fibers for optical connection with other devices, such as closures, multiports, optical transmitters, receivers, isolators, attenuators, amplifiers, power meters, and detectors. When terminating a fiber optic cable with a fiber optic connector, the fiber optic cable should be secured to the fiber optic connector in a suitable manner to withstand pulling and side-load forces that may be experienced during installation and use. Moreover, the termination process should be relatively quick, easy and cost-effective.

Fiber optic connectors may be designed for terminating one specific fiber optic cable design and consequently may have difficultly being adapted for terminating other fiber optic cable designs. For instance, fiber optic cable designs may have different properties such as a jacket materials, strength members, cross-sectional shapes, and/or cross-sectional dimensions. Typically, fiber optic connectors are designed for a specific fiber optic cable design may have difficultly being adapted for other fiber optic cable designs due to the different properties for different fiber optic cables. Further, even the same fiber optic cable design may have manufacturing variations in the outer dimensions that can make terminating the fiber optic cable with a fiber optic connector challenging.

Additionally, different network operators may have a desire to use a specific fiber optic connector for their network, but want to use a fiber optic cable design different from the fiber optic cable that the connector was initially designed to use. Thus, there is an unresolved need for fiber optic connectors or assemblies used for terminating a fiber optic cable with a fiber optic connector while maintaining suitable mechanical performance properties for the cable assembly such as pull-out force, side-pull and the like while maintaining suitable optical performance.

### SUMMARY

The disclosure is directed to fiber optic connectors (hereinafter “connectors”) that allow termination of the connector using several different cable types along with improved mechanical retention of the fiber optic cable to the connector. The disclosure is also directed to cable assemblies having a connector terminated to a fiber optic cable along with methods of making the same.

The fiber optic connectors disclosed provides improved termination along with supporting termination of multiple types of fiber optic cables. The fiber optic connectors, cable assemblies and methods of making the same are also beneficial for terminating fiber optic cables using a mechanical retention without the need for adhesives if desired, thereby making the assembly process easier, quicker and inhibiting the expense and mess of using adhesives.

One aspect of the disclosure is directed to a fiber optic connector comprising a connector assembly having a connector housing and a ferrule, a crimp body, a crimp band sized for fitting about an outer barrel of the crimp body, and a shroud sized for receiving a portion of the crimp body. The crimp body comprises a first shell and a second shell along with a longitudinal passageway extending from a rear end to a front end of the crimp body for receiving an optical fiber therethrough. The first shell comprises a first window formed through a wall of the first shell at a rear portion of the first shell, and the second shell comprises a second window formed through a wall of the first shell at a rear portion of the second shell. The front portion of the crimp body comprises a connector assembly securing portion for securing the connector assembly.

Another aspect of the disclosure is directed to a fiber optic connector comprising a connector assembly having a connector housing and a ferrule, a crimp body, a crimp band sized for fitting about a barrel of the crimp body, and a shroud sized for receiving a portion of the crimp body. The crimp body comprises a first shell and a second shell along with a longitudinal passageway extending from a rear end to a front end of the crimp body for receiving an optical fiber therethrough. The first shell comprises a first window formed through a wall of the first shell at a rear portion of the first shell and comprises wall portions of the first shell formed on four sides of the first window, and the second shell comprises a second window formed through a wall of the first shell at a rear portion of the second shell and comprises wall portions of the second shell formed on four sides of the second window. The front portion of the crimp body comprises a connector assembly securing portion for securing the connector assembly. The fiber optic connector provides improved termination along with supporting termination of multiple types of fiber optic cables.

Yet another aspect of the disclosure is directed to a cable assembly comprising a fiber optic connector terminating a fiber optic cable. The fiber optic connector comprises a connector assembly having a connector housing and a ferrule, a crimp body, a crimp band sized for fitting about an outer barrel of the crimp body, and a shroud sized for receiving a portion of the crimp body. The crimp body comprises a first shell and a second shell along with a longitudinal passageway extending from a rear end to a front end of the crimp body for receiving an optical fiber therethrough. The first shell comprises a first window formed through a wall of the first shell at a rear portion of the first shell, and the second shell comprises a second window formed through a wall of the first shell at a rear portion of the second shell. The front portion of the crimp body comprises a connector assembly securing portion for securing the connector assembly. The fiber optic cable comprises an optical fiber attached to the ferrule, a plurality of strength members, and a cable jacket. The plurality of strength members enter a longitudinal passageway of the crimp body, and a first portion of the plurality of strength members extend from the longitudinal passageway of the crimp body through a first window of disposed on the first shell and are secured between an outer barrel of the crimp body and the crimp band. A second portion of the plurality of strength members extend from the longitudinal passageway of the crimp body through a second window disposed on the second shell and are secured between an outer barrel of the crimp body and the crimp band.

Another aspect of the disclosure is directed to a method of making a cable assembly comprising a fiber optic connector terminating a fiber optic cable. The method includes the steps of preparing an end portion of a fiber optic cable by exposing an optical fiber and a plurality of strength members from a cable jacket at an end portion of the fiber optic cable. Placing a plurality of strength members within a longitudinal passageway of a crimp body comprising a first shell and a second shell of the fiber optic connector. Routing a first portion of the plurality of strength members from the longitudinal passageway of the crimp body through a first window of disposed on the first shell, and routing a second portion of the plurality of strength members from the longitudinal passageway of the crimp body through a second window disposed on the second shell. The method secures the first portion and the second portion of the plurality of strength members between an outer barrel of the crimp body and the crimp band, and attaches the optical fiber to a ferrule of a connector assembly. The connector assembly is secured to a connector assembly securing portion of the crimp body. The method may also include other steps and/or structure as discussed herein.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the disclosure, and are incorporated into and constitute a part of this specification. The drawings illustrate various embodiments and together with the description serve to explain the principles and operation.

### BRIEF DESCRIPTION OF THE FIGURES

FIG. 1 shows a perspective view of a cable assembly having a fiber optic connector as disclosed herein terminated to a representative fiber optic connector;

FIGS. 2-4 depict representative fiber optic cables that may be terminated to the fiber optic connector of FIG. 1;

FIG. 5 shows a partially exploded view of an explanatory cable assembly showing the fiber optic connector of FIG. 1 with the coupling nut omitted for clarity of the illustration;

FIG. 6 shows a perspective view of the crimp body of the fiber optic connector of FIG. 1 comprising a first shell and a second shell with each shell having a window that comprises wall portions of the respective shell formed on four sides of the respective window;

FIG. 7 is a longitudinal sectional view of the assembled fiber optic connector of FIG. 1 taken along line 7-7 with the coupling nut and fiber optic cable removed for clarity;

FIG. 8 is a longitudinal sectional view of the assembled fiber optic connector of FIG. 1 taken orthogonal plane from FIG. 7 with the coupling nut removed for clarity;

FIGS. 9-17 depict the preparation of an explanatory fiber optic cable along with the mechanical attachment of the strength members of the fiber optic cable to the crimp body by routing portions of the strength members through respective windows of the shells of the crimp body and attaching the crimp band for assembling the fiber optic connector; and

FIGS. 18-20 are schematic sectional views showing different explanatory fiber optic cables terminated using the crimp body of the fiber optic connector of FIG. 1.

### DETAILED DESCRIPTION

Reference will now be made in detail to the embodiments of the disclosure, examples of which are illustrated in the accompanying drawings. Whenever possible, like reference numbers will be used to refer to like components or parts.

The concepts disclosed are related to fiber optic connectors having an improved cable termination along with cable assemblies and methods of making the same. The fiber optic connectors (hereinafter “connectors”) disclosed comprise a crimp body comprising a first shell and a second shell that define a longitudinal passageway extending from a rear end to a front end for receiving an optical fiber therethrough. The first shell comprises a first window formed through a wall of the first shell at a rear portion of the first shell. Likewise, the second shell comprises a second window formed through a wall of the second shell at a rear portion of the second shell. The crimp body of the connector allows a mechanical attachment of the strength members of a fiber optic cable to the crimp body by routing first and second portions of the strength members through the respective windows of the first and second shells. Specifically, one or more strength members of the fiber optic cable are routed from a portion of the longitudinal passageway (extending from the rear end to the front end) of the crimp body through the respective windows of the first and second shells so that the strength members may be secured between and outer barrel of the crimp body and a crimp band for transferring tensile forces acting on the fiber optic cable to the strength members secured to the connector.

Thus, the improved cable termination for connectors disclosed herein provide a robust cable termination so that the fiber optic jacket of the fiber optic cable is inhibited from slipping relative to the connector when tensile forces are applied to the terminated fiber optic cable. The concepts are especially helpful for fiber optic cables having cable jackets with relatively a low-coefficient of friction for the cable jacket material. The concepts disclosed herein are shown with an explanatory OptiTap® connector available from Corning Optical Communications, LLC of Charlotte, N.C. However, the concepts disclosed may be used with other fiber optic connectors having a suitable footprint or construction. Additionally, the connector concepts disclosed are advantageous since they allow the termination of several different fiber optic cables as discussed herein. Various designs, constructions, or features for fiber optic connectors or cable assemblies are disclosed in more detail with respect to explanatory embodiments as discussed herein and may be modified or varied as desired.

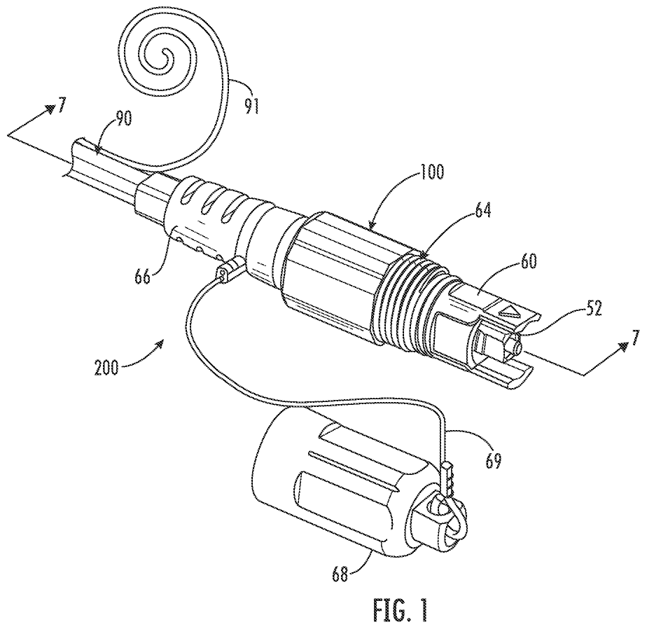

FIG. 1 shows a perspective view of a cable assembly 200 having a connector 100 terminating a fiber optic cable 90. As depicted, the connector 100 is shown with an explanatory OptiTap® connector to illustrate the concepts of the present disclosure, but other connectors may use the concepts disclosed herein. The OptiTap® connector is a well-known connector that is widely deployed by major network operators on a global basis.

FIG. 1 is a perspective view of cable assembly 200 showing fiber optic cable 90 terminated with connector 100. Connector 100 may terminate any suitable fiber optic cable 90. As depicted in FIG. 1, cable 90 is a flat dielectric cable having an optional toning portion that is configured as a toning lobe 91 connected by a web portion, but other fiber optic cables 90 may omit the toning portion as desired. As shown, a portion of toning lobe 91 is separated and coiled before the fiber optic cable 90 enters the connector 100, thereby keeping it out of way. Connector 100 uses a connector assembly 52 of the SC-type, but the concepts may be used with connectors 100 having other types of connector assemblies such as LC, FC, ST, MT, and MT-RJ by using a suitable crimp body.

As depicted, connector 100 comprises a shroud 60 for protecting the connector assembly and keying the connector 100 with a suitable device such as an adapter or other suitable device. Connector 100 may also comprise a coupling nut 64 disposed about a portion of the shroud 60. The coupling nut 64 may rotate about the shroud 60 and has a threaded portion for securing connector 100 engaging complementary threads of a suitable device for optical mating. Connector 100 may also comprise a dust cap 68 for protecting the connector assembly and ferrule end face from dirt, dust, debris or the like. Dust cap 68 may have a threaded portion for engaging the threads of the coupling nut 64 for securing the same. Connector 100 may use other components as desired such as heat shrink sleeves, connector boots and the like.

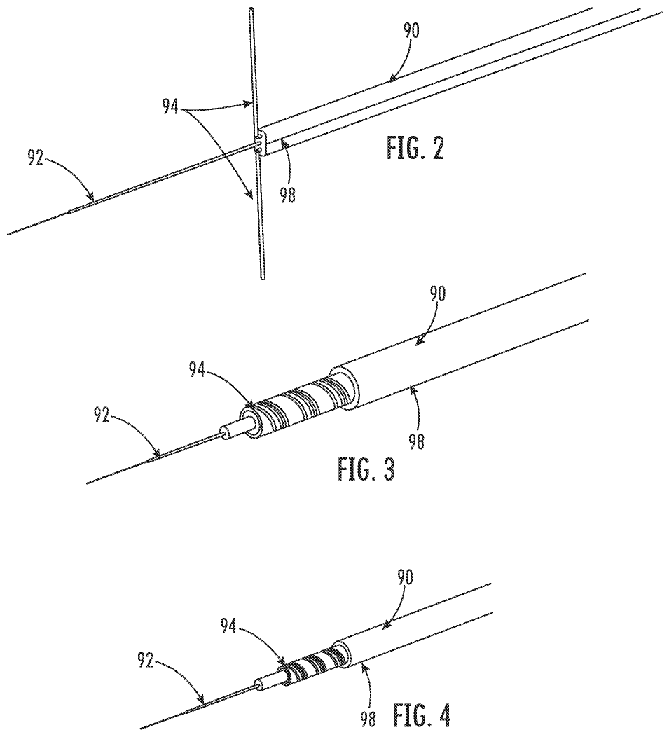

FIGS. 2-4 depict representative fiber optic cables 90 that may be terminated by connector 100. The connector concepts disclosed may advantageously terminate a variety of fiber optic cable having different cable constructions and/or cable component properties. As shown, fiber optic cables 90 of FIGS. 2-4 comprise at least one optical fiber 92, a plurality of strength members 94 and a cable jacket 98. By way of example, suitable cables may have a round or non-round cross-section, may use different strength member such as metal wires or tensile yarns such as aramid yarns, or have cable jackets having different material properties such as cable jackets having a low-coefficient of friction that may not work well with conventional adhesives for strain-relieving or securing the fiber optic cable to the connector. Further, the optical fiber 92 may have a buffer layer disposed about the optical fiber coating(s) and/or be disposed within a buffer tube depending on the fiber optic cable construction.

FIG. 2 depicts a non-round cable (e.g., flat cable) having strength members 94 disposed on either side of the optical fiber 92 as shown. In this fiber optic cable, strength members 94 are two metal wires such as steel wires disposed on opposite sides of the optical fiber 92 and embedded within the cable jacket 98. This fiber optic cable 90 has a low-friction material for the cable jacket that makes it challenging to strain-relieve the cable without movement of the cable jacket 98 relative to the connector 100 during tensile pulling events on the fiber optic cable 90. The connector concepts disclosed route one or more strength members 94 from the longitudinal passageway A-A of the crimp body 55 and through a window of a respective shell 55a of the crimp body so that a portion of the strength members may be captured and secured between an outer barrel 55o of the crimp body 55 and a crimp band 54. The longitudinal passageway A-A of the crimp body 55 extends from a rear end 51 to a front end 59 of the crimp body 55 for receiving an optical fiber 92 of the fiber optic cable 90 therethough so it may be terminated by the connector assembly 52.

The termination of connector 100 to fiber optic cable 90 routes portions of one or more strength members 94 from a portion of the longitudinal passageway A-A of the crimp body 55 through a respective window 53 of the first and shells 55a,55b so they may be secured using the crimp band 54, thereby mechanically securing and strain-relieving the fiber optic cable 90 to the connector 100 while inhibiting movement or slipping of the cable jacket during cable pulling events. Thus, the concepts disclosed offered improved connector-cable termination compared with conventional connector-cable terminations.

The connector-cable termination concepts disclosed do not requires adhesive due to the mechanical routing and retention of the strength members 94; however, the use of an adhesive is possible if desired or not.

Other fiber optic cables 90 may be terminated using connector 100 as well. By way of example, FIG. 3 and FIG. 4 depict round fiber optic cables 90 that may be terminated using connector 100. FIG. 3 depicts a round cable having optical fiber 92 disposed within a buffer tube, thereby forming a larger major cross-sectional dimension or diameter for the fiber optic cable 90. On the other hand, the fiber optic cable of FIG. 4 depicts a round cable that does not have the optical fiber 92 disposed within a buffer tube, thereby forming a smaller major cross-sectional dimension or diameter for the fiber optic cable 90. Strength members 94 of the fiber optic cables 90 of FIG. 4 are disposed radially about the optical fiber 92. The strength members 94 for the fiber optic cable 90 of FIGS. 3 and 4 are tensile yarns such as aramid yarns such as Kevlar® or the like, but other tensile yarns are possible. The fiber optic cables 90 may include other cable components such as ripcords, water-blocking gels, water-swellable materials or the like as desired.

The fiber optic cables terminated by connector 100 may have any suitable size, thereby making the connector 100 useful for a variety of cables. For instance, the fiber optic cables 90 of may have a major cross-sectional dimension of 5 millimeters or less. However, the use of other sizes of fiber optic cables are possible as well. For instance, a flat fiber optic drop may have a major cross-sectional dimension of 10 millimeters or less. Of course, other still other suitable fiber optic cables may be used with the connector concepts disclosed. Moreover, suitable connectors may be used with suitable cables according to the concepts disclosed, thereby resulting in numerous cable/connector combinations for the claimed cable assemblies.

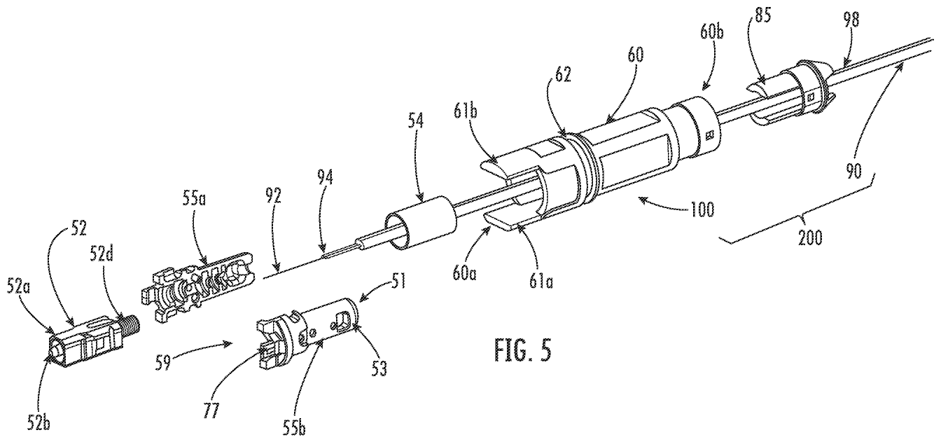

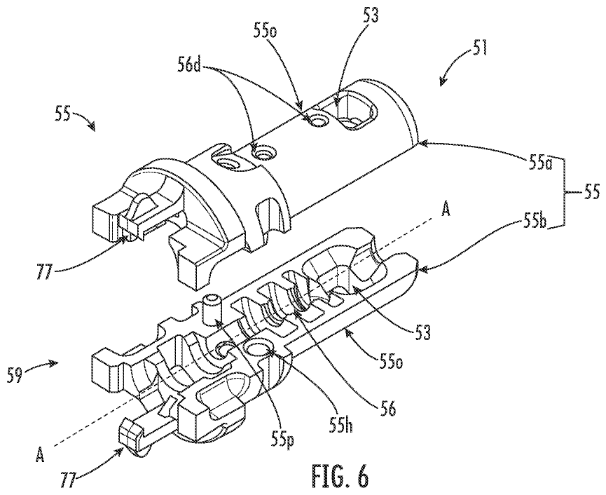

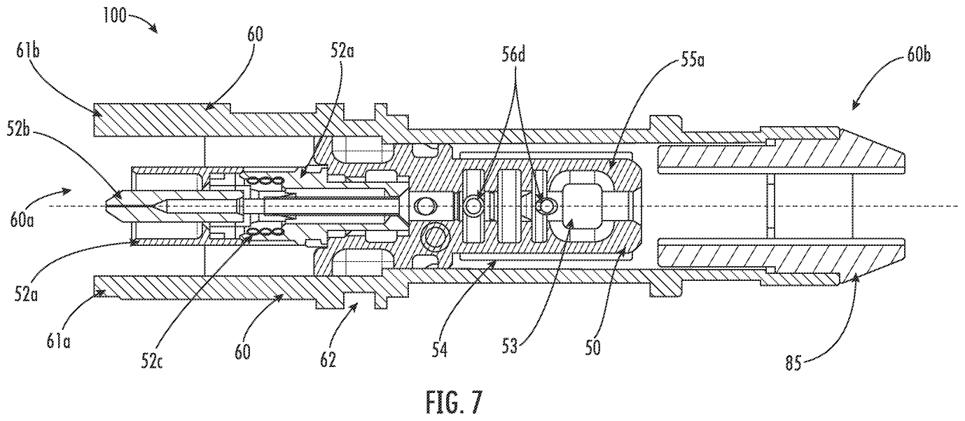

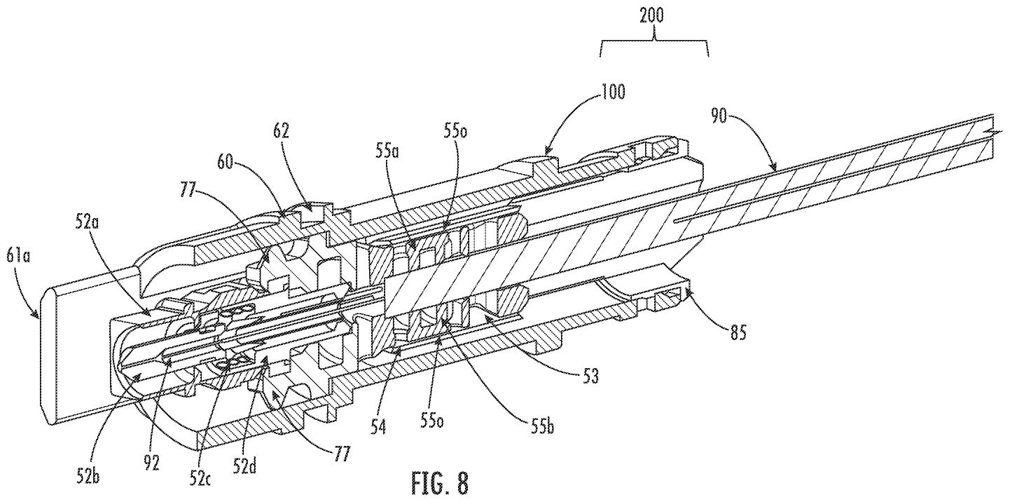

FIG. 5 shows a partially exploded view of an explanatory cable assembly 200 showing the fiber optic connector 100 of FIG. 1 with the coupling nut 64 omitted for clarity of the illustration. FIG. 6 shows a perspective view of the crimp body 55 comprising a first shell 55a and a second shell 55b with each shell 55a,55b having a window 53. As shown, window 53 is a through opening in a sidewall of the respective shell 55a,55b. As shown, window 53 comprises wall portions of the respective shell formed on four sides of the respective window 53 for the first shell 55a and the second shell 55b. FIG. 7 is a longitudinal sectional view of the assembled fiber optic connector of FIG. 1 taken along line 7-7 with the coupling nut and fiber optic cable removed for clarity, and FIG. 8 is a longitudinal sectional view of the assembled fiber optic connector of FIG. 1 taken orthogonal plane from FIG. 7 with the coupling nut removed for clarity.

Further details of the explanatory connector 100 are described below. In this embodiment, connector 100 includes an industry standard SC-type connector assembly 52 having a connector body 52a, a ferrule 52b in a ferrule holder (not numbered), a spring 52c, and a spring push 52d. As discussed, connector 100 uses a crimp assembly (not numbered) that includes crimp body 55 having first shell 55a and second shell 55b each comprising a respective window 53 and a crimp band 54. Connector 100 may further comprise a shroud 60, a coupling nut 64, a cable boot 66, a heat shrink tube 67, a protective cap 68 secured to the connector 100 by a lanyard 69 and/or end piece 85 as desired. Further, the shroud 60 may comprise one or more grooves for receiving respective O-ring 59 for aiding in making a robust connector suitable for outdoor applications.

Generally speaking, most of the components of connector 100 may be formed from a suitable polymer. Preferably, the polymer is a UV stabilized polymer such as ULTEM 2210 available from GE Plastics; however, other suitable materials are possible. For instance, stainless steel or any other suitable metal may be used for various components.

As best shown in FIG. 6, the crimp assembly includes crimp body 55 and crimp band 54. Crimp body 55 has two shells 55a, 55b that are held together by crimp band 54 when assembled, thereby securing the strength members 94 of the terminated fiber optic cable 90. Although, the shells are shown as identical, it is to be understood that other suitable shells are possible using the disclosed concepts. For instance, one shell may have two alignment pins 55P, rather than each shell having a single alignment pin 55P that cooperates with an opposing hole 55h on the other shell. Thus, the alignment of the two shells 55a,55b is accomplished by inserting pins 55P into complementary holes 55h of the two shells. Additionally, shells 55a, 55b may include one or more bores that lead to the longitudinal passageways for inserting an adhesive or epoxy into the crimp body if desired.

Crimp band 54 is preferably made from brass, but other suitable crimpable materials may be used such as aluminum or the like. Crimp body 55 is configured for securing connector assembly 52 as well as providing strain relief to fiber optic cable 90. This advantageously results in a relatively compact connector arrangement using fewer components. Moreover, the crimp assembly allows quick and easy assembly. Of course, other embodiments are possible according to the present invention. For instance, connector body 52a may be integrally molded into crimp housing 55 in a ST type configuration so that a twisting motion of the crimp housing secures the ST-type connector with a complementary mating receptacle.

FIG. 6 shows the inner surface of one shell 55b. In this case, the shells 55a,55b are illustrated as two similar shells are used as each half of crimp body 55, thereby simplifying the design by using fewer number of different parts. In other embodiments there may be a first shell and a second shell that are different. As shown in FIG. 6, shell 55a includes front end 59 for securing connector assembly 52 and rear end 51 used for cable strain-relief. A longitudinal axis A-A is formed between rear end 51 and the front end 59 near the center of crimp body 55. When assembled, optical fiber 92 passes through the longitudinal passage and is held in a bore of ferrule 52b. The shells 55a,55b may also have cable alignment or clamping portions configured as a central neck-down or rib potions that are generally disposed along longitudinal axis A-A. Also shown are bores 56d allow for inserting an adhesive or epoxy into the crimp body 55 if desired or not.

As shown in FIG. 7, when fully assembled the crimp body 55 fits into shroud 60. Additionally, crimp body 55 is keyed to direct the insertion of the crimp assembly into shroud 60. In this case, shells 55a,55b may include planar surfaces on opposites sides of crimp body 55 to inhibit relative rotation between crimp body 55 and shroud 60. In other embodiments, the crimp assembly may be keyed to the shroud using other configurations such as a complementary protrusion/groove or the like.

As best shown in FIG. 5, shroud 60 has a generally cylindrical shape with a first end 60a and a second end 60b. Shroud generally protects connector assembly 52. Shroud (60) may be configured for keying connector 100 with the respective mating device such as a receptacle or the like. Shroud (60) can be configured for keying connector 100 by having an asymmetrical front end such that only allows mating of the connector 100 in one orientation. By way of example, shroud (60) may have a first alignment finger with a first shape (e.g., cross-section or the like) and a second alignment finger with a second shape that is different than the first shape. Moreover, shroud 60 includes a through passageway between first and second ends 60a and 60b. As discussed, the passageway of shroud 60 is keyed so that crimp body 55 is inhibited from rotating when connector 100 is assembled. Additionally, the passageway has an internal shoulder (not numbered) that inhibits the crimp assembly from being inserted beyond a predetermined position as depicted in FIG. 7.

As shown, the first end 60a of shroud 60 includes at least one opening (not numbered) defined by shroud 60. The at least one opening extends from a medial portion of shroud 60 to first end 60a. In this case, shroud 60 includes a pair of openings on opposite sides of first end 60a, thereby defining alignment portions or fingers 61a,61b. In addition to aligning shroud 60 with receptacle or other device during mating, alignment fingers 61a,61b may extend slightly beyond connector assembly 52, thereby protecting the same. However, the concepts may be practiced without the shroud extending beyond the connector assembly 52. As shown in FIG. 5, alignment fingers 61a,61b have different shapes so the connector 100 only mates in one orientation. In preferred embodiments, this orientation is marked on shroud 60 using alignment indicia so that the user can quickly and easily mate the connector 100 with receptacle. For instance, alignment indicia may be an arrow molded into the top alignment finger of shroud 60 as shown in FIG. 1, however, other suitable indicia may be used. The arrow may be aligned with complimentary alignment indicia disposed on a receptacle or the like, thereby allowing the user to quickly and easily align the connector with the different sized alignment fingers. Thereafter, the user may engages the external threads of coupling nut 64 with the complimentary internal threads of receptacle or other device for making the optical connection.

A medial portion of shroud 60 may have a groove 62 for seating an O-ring. The O-ring provides a weatherproof seal between connector 100 and the receptacle or protective cap 68. The medial portion also includes a shoulder that provides a stop for coupling nut 64. Coupling nut 64 has a passageway sized so that it fits over the second end 60b of shroud 60 and easily rotates about the medial portion of shroud 60. In other words, coupling nut 64 cannot move beyond shoulder, but coupling nut 64 is able to rotate with respect to shroud 60. The second end 60B may also be sized for receiving end piece 85 into the passageway as depicted in FIG. 7. The end piece 85 may aid in cable bend performance at the interface between the fiber optic cable 90 and connector 100. The end piece 85 may also be tailored for the specific fiber optic cable 90 that is terminated by the connector 100, by easily using a different shaped end piece 85 designed for the particular cable.

Second end 60b of shroud 60 includes a stepped down portion having a relatively wide groove (not numbered). This stepped down portion and groove are used for securing heat shrink tubing. Heat shrink tubing 67 is used for weatherproofing the transition between the connector 100 and fiber optic cable 90 when assembled. Specifically, the stepped down portion and groove allow for the attachment of heat shrink tubing to the second end 60b of shroud 60. The other end of heat shrink tubing is formed about the cable jacket 98, thereby inhibiting water from entering connector 100.

After the heat shrink tubing is attached, the boot 66 is slid over heat shrink tubing and a portion of shroud 60. Boot 66 is preferably formed from a flexible material such as KRAYTON. Heat shrink tubing and boot 66 generally inhibit kinking and provide bending strain relief to the cable near connector 100. Boot 66 has a longitudinal passageway (not visible) with a stepped profile therethrough. The first end of the boot passageway is sized to fit over the second end of shroud 60 and heat shrink tubing.

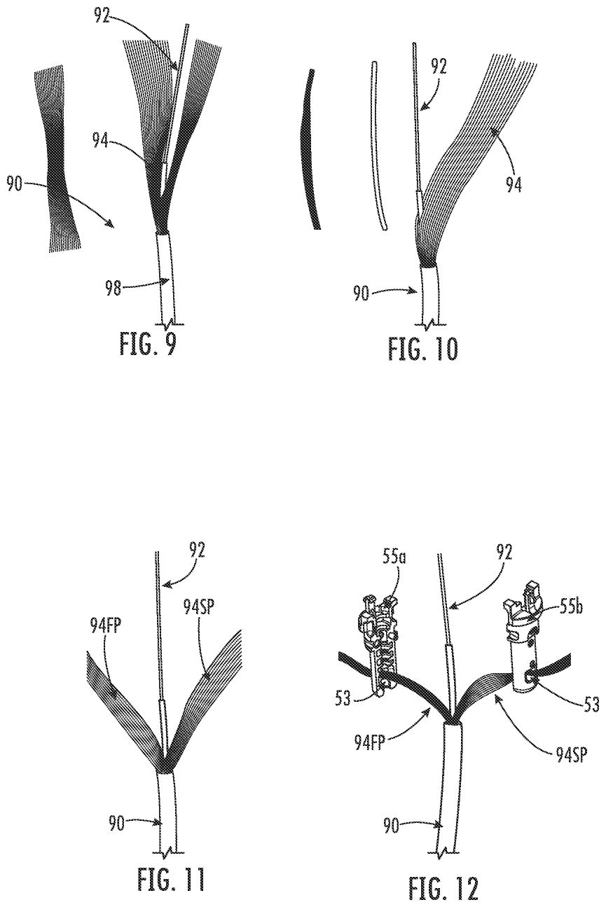

FIGS. 9-17 depict the preparation of an explanatory fiber optic cable 90 for termination along with the mechanical attachment of the strength members 94 of the fiber optic cable 90 to the crimp body 55 using the crimp band 54. This example shows the preparation of the fiber optic cable of FIG. 4 for termination and attachment of the crimp assembly to the fiber optic cable 90.

FIGS. 9-11 depict the preparation of an end portion of fiber optic cable 90 for termination with connector 100 so that the crimp assembly may be secured to the fiber optic cable 90. FIG. 9 illustrates fiber optic cable 90 having an end prepared for termination with a portion of cable jacket 98 cut and stripped from the cable, thereby exposing optical fiber 92 and the strength members 94. As needed or not, a portion of the strength members 94 may be cut flush with the stripped back jacket 98 if the fiber optic cable has excess strength members for termination to the crimp assembly. FIG. 10 depicts the trimming of a portion of the binder thread along with the removal of a portion of a polymer tight-buffer layer from the optical fiber 92. FIG. 11 depicts the removal of one or more protective coating(s) from the optical fiber 92 along with the separation of the plurality of strength members 94 into a first portion 94FP of strength members and a second portion 94SP of strength members.

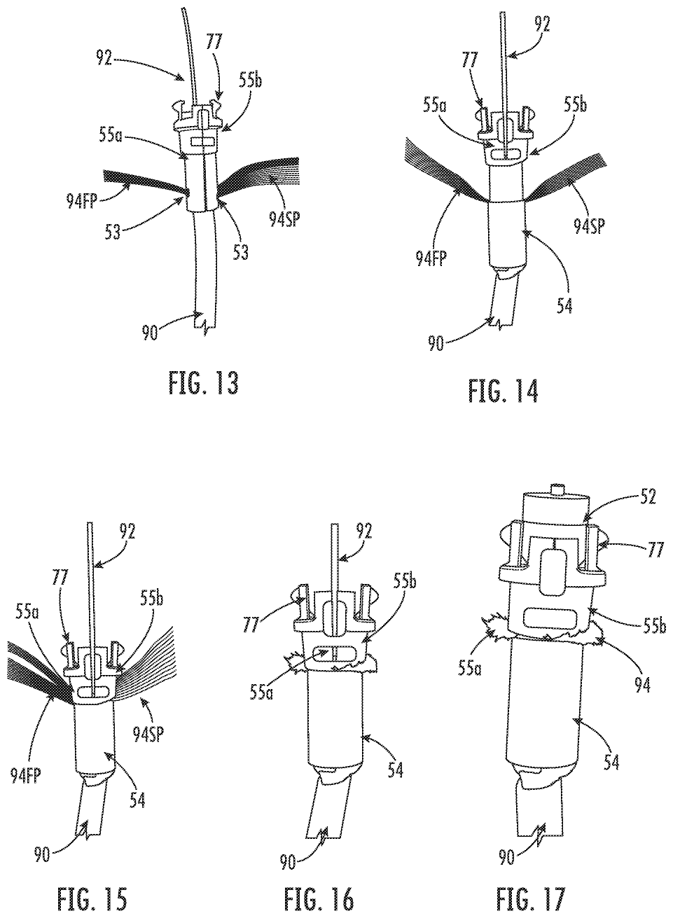

FIG. 12 shows the routing of the first portion 94FP portion of the strength members 94 from the longitudinal passageway of the crimp body 55 through the first window 53 of the first shell 55a of the crimp body 55. Likewise, FIG. 12 shows the routing of the second portion 94FP portion of the strength members 94 from the longitudinal passageway of the crimp body 55 through the second window 53 of the second shell 55a of the crimp body 55. FIG. 13 depicts the first and second shells 55a, 55b aligned and pushed together so that respective the pins and holes 55P,55h of the shells 55a,55b engage along with the optical fiber 92 passing through the longitudinal passageway of the crimp body 55 past the front end 59 of the crimp body 55. Thereafter, the crimp band 54 previously threaded onto the fiber optic cable 90 may be slid-forward from the fiber optic cable 90 onto a portion of the first and second shells 55a,55b of the crimp body 55 as depicted in FIG. 14 until it is in the proper position on the crimp body 55 as shown in FIG. 15. Consequently, the first portion 94FP of the plurality of strength members 94 and the second portion 94SP of the plurality of strength members that exit the respective windows 53 are disposed between an outer barrel 55o of the crimp body 55 and the crimp band 54 as shown.

Next, the crimp band 54 is deformed about the crimp body 55 using a suitable tool, thereby securing the first portion 94FP and second portion 94SP of the plurality of strength members 94 between an outer barrel 55o of the crimp body 55 and the crimp band 54. Thus, the first portion 94FP and second portion 94SP of strength members are secured to the crimp assembly using a mechanical retention without the use of adhesive. This termination of the connector 100 onto fiber optic cable inhibits a cable jacket 98 with a low-friction cable jacket material from moving during tensile pulling events. FIG. 16 shows the excess length of the first portion 94FP and second portion 94SP trimmed from the assembly.

FIG. 17 depicts connector assembly 52 attached to the optical fiber 92. Specifically, the optical fiber is attached to ferrule 52b of connector assembly 52 and the connector body 52a is secured to the crimp body (55). More specifically, connector assembly 52 is attached to crimp body 55 by snap-fitting with the interlocking fingers 77 disposed on the front portion the crimp body 55 on opposite sides of crimp body 55. Interlocking fingers 77 are configured for cooperating with the latching recesses (not numbered) formed on the opposite side of the connector housing 52a of the connector assembly 52. As depicted, each respective shell 55a,55b has an interlocking finger 77 for engaging a respective latching recess of the connector housing 52a. The end face of the ferrule 52b of connector assembly 52 may be polished as known in the art. The remainder of connector 100 may be assembled as discussed and shown herein such as sliding the shroud 60 and end piece 85 forward on the fiber optic cable for assembly.

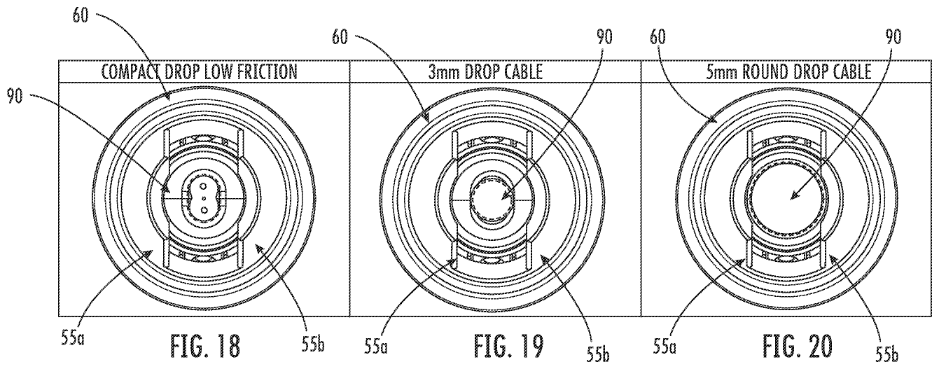

FIGS. 18-20 are schematic sectional views showing different explanatory fiber optic cables 90 of FIGS. 2-4 secured to the crimp body 55 having windows 53 for routing the strength members 94 as described herein and securing the same using crimp band 54 for the fiber optic connector 100. Of course, the longitudinal passageway of the crimp body 55 may have the passageway tailor-made for a specific cable design if desired.

Although the disclosure has been illustrated and described herein with reference to explanatory embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

We claim:

1. A fiber optic connector comprising:
a connector assembly, the connector assembly comprising a connector body and a ferrule;
a crimp body comprising a first shell and a second shell, the crimp body comprising a longitudinal passageway extending from a rear end to a front end for receiving an optical fiber therethrough, wherein the first shell comprises a first window formed through a wall of the first shell at a rear portion of the at the first shell, and the second shell comprises a second window formed through a wall of the second shell at a rear portion of the at the second shell, wherein the front portion of the crimp body comprises a connector assembly securing portion for securing the connector assembly;
a crimp band sized for fitting about an outer barrel of the crimp body; and
a shroud sized for receiving a portion of the crimp body, and the shroud is configured for keying the fiber optic connector.

2. The fiber optic connector of claim 1, wherein the first window comprises wall portions of the first shell formed on four sides of the first window.

3. The fiber optic connector of claim 1, wherein the second window comprises wall portions of the second shell formed on four sides of the second window.

4. A fiber optic connector comprising:
a connector assembly, the connector assembly comprising a connector body and a ferrule;
a crimp body comprising a first shell and a second shell along with a longitudinal passageway extending from a rear end to a front end of the crimp body for receiving an optical fiber therethrough, wherein the first shell comprises a first window formed through a wall of the first shell at a rear portion of the at the first shell and comprises wall portions of the first shell formed on four sides of the first window, and the second shell comprises a second window formed through a wall of the second shell at a rear portion of the at the second shell and comprises wall portions of the second shell formed on four sides of the second window, wherein the front portion of the crimp body comprises a connector assembly securing portion for securing the connector assembly;
a crimp band sized for fitting about an outer barrel of the crimp body; and
a shroud sized for receiving a portion of the crimp body, and the shroud is configured for keying the fiber optic connector.

5. The fiber optic connector of claim 1, wherein the connector assembly securing portion is configured as a first interlocking finger and a second interlocking finger.

6. The fiber optic connector of claim 1, wherein the connector assembly comprises an SC-type of connector.

7. The fiber optic connector of claim 1 being a portion of a cable assembly.

8. A cable assembly comprising a fiber optic connector terminating a fiber optic cable, comprising:
the fiber optic connector, comprising:
a connector assembly, the connector assembly comprising a connector body and a ferrule;
a crimp body comprising a first shell and a second shell along with a longitudinal passageway extending from a rear end to a front end of the crimp body for receiving an optical fiber therethrough, wherein the first shell comprises a first window formed through a wall of the first shell at a rear portion of the at the first shell, and the second shell comprises a second window formed through a wall of the second shell at a rear portion of the at the second shell, wherein the front portion of the crimp body comprises a connector assembly securing portion for securing the connector assembly;
a crimp band sized for fitting about an outer barrel of the crimp body;
a shroud sized for receiving a portion of the crimp body, and the shroud being configured for keying the fiber optic connector; and
the fiber optic cable, comprising:
an optical fiber, wherein the optical fiber is attached to the ferrule;
a plurality of strength members, wherein the plurality of strength members enter the longitudinal passageway of the crimp body, wherein a first portion of the plurality of strength members extend from the longitudinal passageway of the crimp body through the first window disposed on the first shell and are secured between an outer barrel of the crimp body and the crimp band, and wherein a second portion of the plurality of strength members extend from the longitudinal passageway of the crimp body through the second window disposed on the second shell and are secured between an outer barrel of the crimp body and the crimp band; and
a cable jacket.

9. The cable assembly of claim 8, wherein the first window comprises wall portions of the first shell formed on four sides of the first window, and the second window comprises wall portions of the second shell formed on four sides of the second window.

10. The cable assembly of claim 8, wherein fiber optic cable comprises a major cross-sectional dimension of about 5 millimeters or less.

11. The cable assembly of claim 8, wherein the fiber optic cable comprises a round cross-section or a non-round cross-section.

12. The cable assembly of claim 8, wherein termination of the fiber optic connector to the fiber optic cable excludes an adhesive disposed within the crimp body.

13. A method of making a cable assembly comprising a fiber optic connector terminating a fiber optic cable, comprising:
preparing an end portion of a fiber optic cable by exposing an optical fiber and a plurality of strength members from a cable jacket at the end portion of the fiber optic cable;
placing a plurality of strength members within a longitudinal passageway of a crimp body comprising a first shell and a second shell of the fiber optic connector;
routing a first portion of the plurality of strength members from the longitudinal passageway of the crimp body through a first window of the first shell;
routing a second portion of the plurality of strength members from the longitudinal passageway of the crimp body through a second window of the second shell;
securing the first portion and the second portion of the plurality of strength members between an outer barrel of the crimp body and a crimp band; and
attaching the optical fiber to a ferrule of a connector assembly and securing a connector body of the connector assembly to a connector assembly securing portion the crimp body.

14. The method of claim 13, comprising placing the crimp body within a portion of a shroud, wherein the shroud is configured for keying the fiber optic connector.

15. The method of claim 13, wherein the first window comprises wall portions of the first shell formed on four sides of the first window, and the second window comprises wall portions of the second shell formed on four sides of the second window.

16. The method of claim 13, wherein fiber optic cable comprises a major cross-sectional dimension of about 5 millimeters or less.

17. The method of claim 13, wherein the fiber optic cable comprises a round cross-section or a non-round cross-section.

18. The method of claim 13, wherein the connector assembly securing portion is configured as a first interlocking finger and a second interlocking finger.

19. The method of claim 13, wherein the connector assembly comprises an SC-type of connector.

20. The method of claim 14, further comprising placing a coupling nut about the shroud.
